(19) United States
(12) Patent Application Publication
(10) Pub. No.: US 2008/0309472 A1
(43) Pub. Date: Dec. 18, 2008

(54) Vehicle power source for home-vehicle communications link

(75) Inventor: Hakan Kostepen, Peachtree City, GA (US)

Correspondence Address: PANASONIC AUTOMOTIVE SYSTEM;COMPANY OF AMERICA, 776 HWY 74 SOUTH, PEACHTREE CITY, GA, 30269, US

(73) Assignee: Panasonic Automotive Systems Co. of America ˜ Division of Panasonic Corp. of North America, Peachtree City, GA (US)

(21) Appl. No.: 11/818,487

(22) Filed: Jun. 14, 2007

(51) Int. Cl. B60Q 1/00

(52) U.S. Cl. 340/455

(57) ABSTRACT

An infotainment system for a vehicle having a first source of electrical power includes an audio/video apparatus installed in the vehicle. An external personal electronic device operates outside of the vehicle. A communications link is communicatively coupled to each of the audio/video apparatus and the external personal electronic device. The communications link is installed in the vehicle and transfers electronic infotainment content between the audio/video apparatus and the external personal electronic device. The transferring includes communicating with air-borne signals between the communications link and the external personal electronic device. The communications link is powered by the first source of electrical power when an engine of the vehicle is in an ON state. An electrical energy storage device is electrically connectable to the communications link. The electrical energy storage device powers the communications link when the engine of the vehicle is in an OFF state.

### BACKGROUND OF THE INVENTION

1. Field of the Invention

The present invention relates generally to electronic file transfer systems for vehicle infotainment systems, and, more particularly, to power supply arrangements for such electronic file transfer systems.

2. Description of the Related Art

Transferring digital audio/video files from one medium to another has become commonplace. For example, digital files containing music or motion pictures may be downloaded from the internet onto the hard drive of a personal computer (PC). The music or motion pictures may then be played back on the monitor and speakers of the PC. It is also possible to transfer the audio/video files from the PC to a memory device in another playback system, such as a home stereo system or an audio/video system of a vehicle. In the case of file transfer to the audio/video system of an automobile, the automobile may be in close proximity to the PC while the files are wirelessly transferred via a local area network (LAN) link, also known as Wi-Fi. During the file transfer, the PC may be located in a house, while the automobile is located in garage or driveway of the house, for example.

One problem to be overcome with the above-described file transfer scenario is the limited amount of electrical energy that is available within the vehicle to accomplish the reception and storage of the files. The file transfers typically occur while the engine of the vehicle is not running, and thus the battery of the vehicle is not being recharged by the alternator. If too much electrical energy from the battery is used in the file transfer process, there may not be enough charge left in the battery to start the engine, which requires a substantial level of current. Thus, vehicle manufacturers may put strict limits on the level of power that accessories may draw, such as for file transfers, while the engine is not running.

No matter how low the power level that is required to effect the file transfer, and no matter the capacity of the battery, if the time duration of the file transfer process is long enough, it is still possible for the file transfer to drain the battery such that it is no longer capable of starting the engine. A dead battery may be, at a minimum, extremely inconvenient to the operator of the vehicle.

What is needed in the art is a system for transferring audio/video files to the audio/video system of a vehicle that is not at risk of draining the battery of the vehicle to a point where the engine of the vehicle cannot be started.

### SUMMARY OF THE INVENTION

The present invention is directed to a vehicle including a wireless home-vehicle link that may receive audio/video files, such as via air-borne signals, and that may store the files in a memory device within the vehicle. Although a standard source of electrical energy (e.g., a battery) may be used to power the home-vehicle link while an engine of the vehicle is running (i.e., is recharging the source of electrical energy), a separate electrical energy storage device is used to power the home-vehicle link while the engine is not running.

The invention comprises, in one embodiment thereof, an infotainment system for a vehicle having a first source of electrical power. The infotainment system includes an audio/video apparatus installed in the vehicle. An external personal electronic device operates outside of the vehicle. A communications link is communicatively coupled to each of the audio/video apparatus and the external personal electronic device. The communications link is installed in the vehicle and transfers electronic infotainment content between the audio/video apparatus and the external personal electronic device. The transferring includes communicating with air-borne signals between the communications link and the external personal electronic device. The communications link is powered by the first source of electrical power when an engine of the vehicle is in an ON state. An electrical energy storage device is electrically connectable to the communications link. The electrical energy storage device powers the communications link when the engine of the vehicle is in an OFF state.

The invention comprises, in another embodiment thereof, a method of operating an audio/video apparatus in a vehicle. A first source of electrical power and a communications link are provided in the vehicle. The communications link is coupled to the audio/video apparatus. An external personal electronic device is disposed outside of the vehicle. The communications link is used to transfer electronic infotainment content from one of the audio/video apparatus and the external personal electronic device to the other of the audio/video apparatus and the external personal electronic device. The transferring includes communicating with air-borne signals between the communications link and the external personal electronic device. An electrical energy storage device is provided in the vehicle. The communications link is powered with the first source of electrical power when an engine of the vehicle is in an ON state. The communications link is powered with the electrical energy storage device when the engine of the vehicle is in an OFF state.

The invention comprises, in yet another embodiment thereof, a vehicle includes an engine having an ON state and an OFF state. An audio/video apparatus includes a memory device. A communications link is electrically connected to the audio/video apparatus. The communications link transfers electronic infotainment content from an external source to the memory device of the audio/video apparatus. A first source of electrical power provides power to the communications link when the engine is in the ON state. An electrical energy storage device is electrically connected to the communications link. The electrical energy storage device powers the communications link when the engine is in the OFF state.

The invention comprises, in a further embodiment thereof, an infotainment arrangement for a vehicle having an engine and an electrical power source. The engine has an ON state and an OFF state. The arrangement includes an audio/video device installed in the vehicle and adapted to process infotainment content. A memory device stores the infotainment content. A communications link is coupled to the audio/video device and the memory device. The communications link receives air-borne signals generated externally of the vehicle, the air-borne signals including the infotainment content. The communications link is electrically coupled to and powered by an electrical energy storage device when the engine is in the OFF state, and is electrically connected to and powered by the vehicle's electrical power source when the engine is in the ON state.

An advantage of the present invention is that the file transfer process does not drain the vehicle battery, and thus does not risk leaving the battery with insufficient energy to start the engine of the vehicle.

Another advantage is that, while the engine of the vehicle is running, the vehicle battery/alternator combination may power the home-vehicle link as well as recharge the electrical energy storage device that powers the link when the engine is not running.

### BRIEF DESCRIPTION OF THE DRAWINGS

The above-mentioned and other features and advantages of the invention will become more apparent to one with skill in the art upon examination of the following figures and detailed description. The components in the figures are not necessarily to scale, emphasis instead being placed upon illustrating the principles of the invention. Moreover, in the figures, like reference numerals designate corresponding parts throughout the different views.

FIG. 1 is a block diagram of one embodiment of an infotainment system of the present invention.

FIG. 2 is a block diagram of one embodiment of an electrical power distribution system suitable for the vehicle of the infotainment system of FIG. 1.

FIG. 3 is a flow chart of one embodiment of a method of the present invention for operating an audio/video apparatus.

FIG. 4 is a flow chart of another embodiment of a method of the present invention for operating an audio/video apparatus.

### DETAILED DESCRIPTION OF THE PRESENTLY PREFERRED EMBODIMENTS

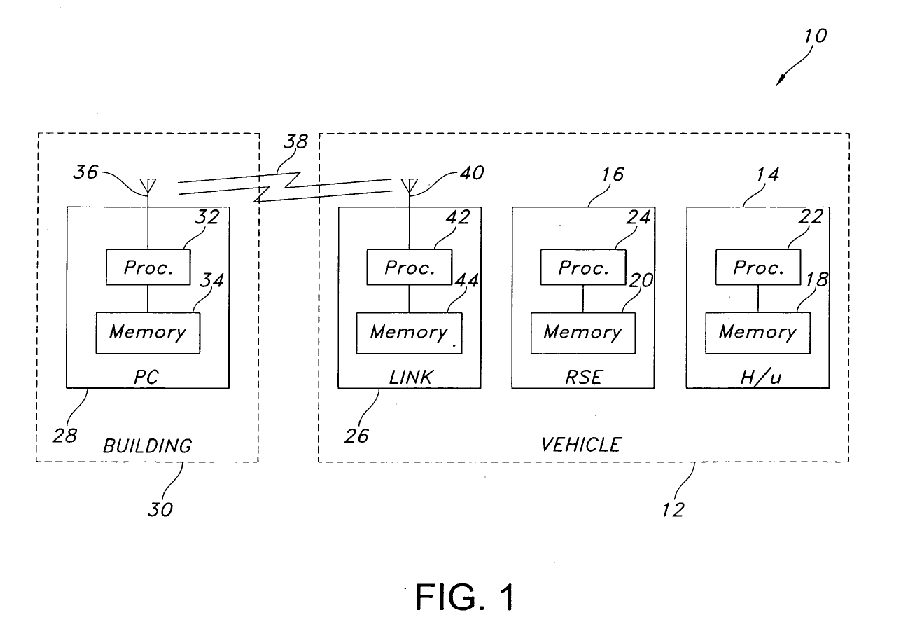

Referring to FIG. 1, there is shown one embodiment of a vehicle infotainment system 10 of the present invention for a vehicle 12. Installed in vehicle 12 are an audio/video head unit 14 and another audio/video apparatus in the form of a rear seat entertainment (RSE) system 16. Head unit 14 and/or RSE 16 are for playing audio/video infotainment content, such as may be included in radio signals, satellite signals, compact discs (CDs), DVDs, MP3 files and other electronic audio and/or video media in a passenger compartment of vehicle 12. More particularly, each of head unit 14 and RSE 16 may include, or be in communication with, one or more speakers (not shown) and/or display monitors (not shown) for playing audio/video content that may be received in a live broadcast, or that may be stored in memory devices 18, 20. Processors 22, 24 may process the audio/video content and transmit appropriate signals to the speakers and/or display monitors for playback of the audio/video content. The term “audio/video” as used herein is to be understood as including audio without video, video without audio, or both audio and video.

Vehicle 12 includes a communications link 26, which may be referred to as a “wireless home-vehicle link”, for receiving and storing audio/video infotainment content from an external personal electronic device 28, which may operate outside of vehicle 12 and may be disposed in a building 30. Building 30 may be a residential building, such as a house, and vehicle 12 may be disposed in a garage or on a driveway of building 30 during the process of transferring the infotainment content. In one embodiment, device 28 is in the form of a personal computer (PC) including a processor 32 that may retrieve audio/video content stored in a memory device 34. Processor 32 may cause air-borne, radio frequency signals that carry the audio/video content to be broadcast from an antenna 36, as indicated at 38.

Link 26 may include an antenna 40 for wirelessly receiving the air-borne signals that are transmitted by antenna 36. Thus, link 26 may be communicatively coupled to each of PC 28, head unit 14 and RSE 16. The electronic infotainment content may be transferred between PC 28 and at least one of head unit 14 and RSE 16 by the communication of air-borne signals between link 26 and PC 28. A processor 42 of link 26 may store the received audio/video content in a memory device 44 for later transfer to, and playback by, RSE 16 and/or head unit 14. Alternatively, or in addition, processor 42 may immediately transfer the audio/video content to RSE 16 and/or head unit 14 for storage in memory device 20 and/or memory device 18. By virtue of being stored in at least one of memory devices 18, and 44, the audio/video content may be played back by speakers and/or display monitors of head unit 14 and RSE 16 at some later point in time.

Processors 22, 24, 42, and memory devices 18, 20, 44 are depicted in FIG. 1 as being connected together by single conductors. However, any or all of these components may communicate via one or more communication busses and data busses.

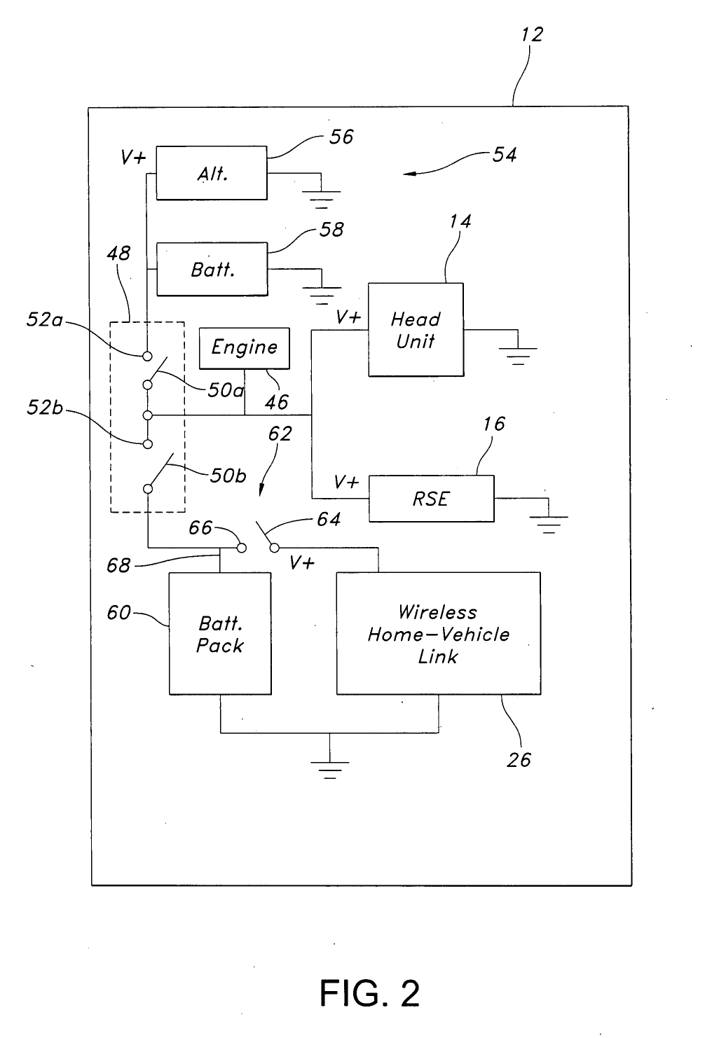

An arrangement of the present invention for supplying electrical power to communications link 26 is illustrated in FIG. 2. Vehicle 12 may include an engine 46 having an ON state in which the engine is running and an OFF state in which the engine is not running. Whether engine 46 is in the ON state or is in the OFF state may depend upon the position of an ignition switch 48. Switch 48 may be a double pole, single throw (DPST) switch having an OFF position as shown in FIG. 2 in which poles 50a, 50b do not engage contacts 52a, 52b, and an ON position in which poles 50a, 50b engage contacts 52a, 52b, respectively. In the embodiment shown, poles 50a, 50b may be actuated in unison such that poles 50a, 50b are engaged with, or disengaged from, respective contacts 52a, 52b at the same times. Switch 48 may be actuated from the OFF position to the ON position as a result of the user turning a key (not shown), as is well known.

When switch 48 is in the OFF position as shown in FIG. 2, engine 46 is electrically disconnected from a source of electrical power 54 within vehicle 12. Power source 54 may include an alternator 56 and/or a battery 58. Because engine 46 is disconnected from power, the ignition system (not shown) of the engine may not have power available with which to start engine 46 and to keep it running. Thus, switch 48 being in the OFF position may correspond to engine 46 being in the OFF state.

Conversely, when switch 48 is in the ON position, i.e., when poles 50a, 50b are engaged with, or electrically connected to, respective contacts 52a, 52b, engine 46 may be connected to electrical power from source 54. Because engine 46 is connected to power, the engine ignition system may have power available with which to start engine 46 and to keep it running. Thus, switch 48 being in the ON position may correspond to engine 46 being in the ON state. The running of engine 46 may rotationally drive alternator 56, which recharges battery 58 and keeps the output voltage of battery 58 within a desired range, as is well known.

The closing of switch 48, i.e., the placing of switch 48 in the ON position, also applies voltage to head unit 14, to RSE 16, and to a suitable electrical energy storage device, which in the embodiment of FIG. 2 is a rechargeable battery pack 60. The voltage thus applied to head unit 14 and RSE 16 enables head unit 14 and RSE 16 to operate. Battery pack 60 may have an output voltage that is lower than the output voltage of battery 58 such that battery pack 60 may be recharged by battery 58 and/or by alternator 56 when switch 48 is in the ON position, even in the presence of voltage drops between battery 58 and battery pack 60.

A single pole, single throw switch 62 may be used to selectively apply operating voltage to communications link 26, i.e., to selectively turn link 26 ON and OFF. Switch 62 is shown in FIG. 2 in the open, i.e., OFF, position wherein voltage is not applied to communications link 26. When switch 62 is actuated by the user into the closed or ON position such that pole 64 engages, or is electrically connected to, contact 66, then electrical power may be applied to link 26 by battery 58 or by battery pack 60, depending upon the position of switch 48. More particularly, when both of switches 48, 62 are in the ON position, voltage from battery 58 may be applied to link 26 to power the operation of link 26. Regardless of the position of switch 62, i.e., regardless of whether switch 62 is in the ON position or the OFF position, battery pack 60 may be recharged by battery 58 and/or alternator 56 when switch 48 is in the ON position. It should be noted that when switch 48 is closed, engine 46 may be running and mechanically driving alternator 56 such that battery 58 and battery pack 60 may be recharged.

The user may typically choose to operate communications link 26 with vehicle 12 being stationary, and thus there may be no need for engine 46 to be running during the transfer of infotainment content to link 26, head unit 14, and/or RSE 16. For this reason, link 26 may usually be operated while switch 48 is open and link 26 is disconnected from power source 54. With switch 48 open, i.e., with engine 46 in an OFF state, link 26 may be powered by battery pack 60 when the user closes switch 62. Although battery pack 60 may not be getting recharged while switch 48 is open and switch 62 is closed, operation of link 26 will not drain battery 58 and thus will not risk leaving battery 58 with a charge that is insufficient to start engine 46.

Battery pack 60 may be movable or removable from vehicle 12 such that battery pack 60 can be recharged by a stand-alone charging device (not shown). It is possible for such recharging to occur while battery pack 60 remains in vehicle 12 and/or while battery pack 60 is powering the operation of link 26.

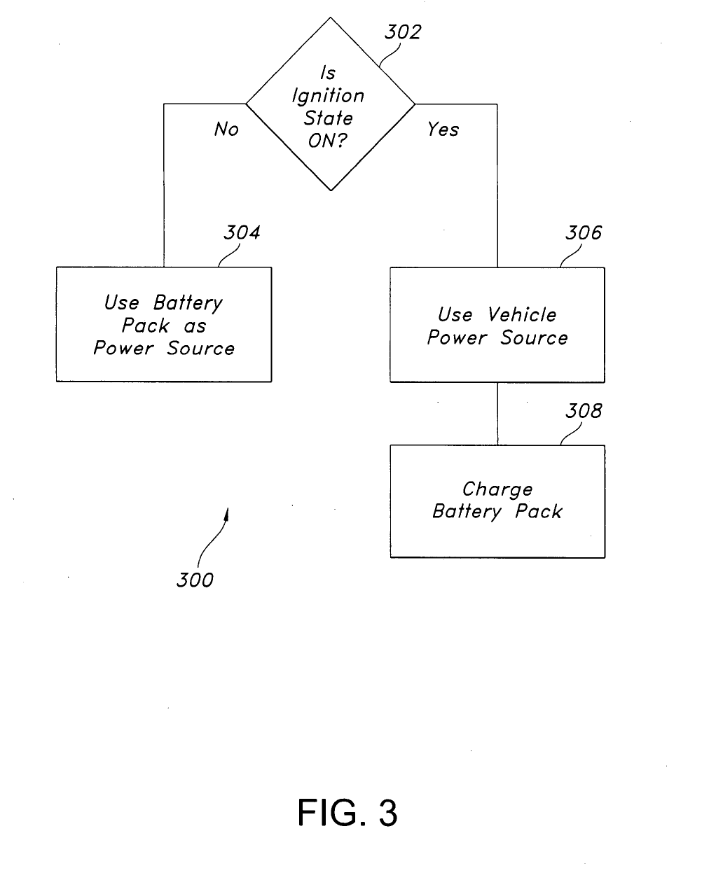

FIG. 3 illustrates one embodiment of a method 300 of the present invention for operating an audio/video apparatus in a vehicle. In step 302, it is determined whether an ignition state is ON. For example, in the case of infotainment system 10 as shown in FIGS. 1-2, ignition switch 48 may be in an ON position (closed), corresponding to an ignition state being ON, or ignition switch 48 may be in an OFF position (open), corresponding to an ignition state being OFF. If the ignition state is OFF, e.g., switch 48 is open, then a battery pack is used as a power source (step 304). In the embodiment of FIGS. 1-2, assuming that switch 62 is closed (i.e., the user has turned on communications link 26), battery pack 60 is used as a source of electrical power for the operation of communications link 26. If, on the other hand, the ignition state is ON, e.g., switch 48 is closed, then a vehicle power source is used as a power source (step 306). In the embodiment of FIGS. 1-2 (again assuming that switch 62 is closed), electrical power source 54, including alternator 56 and battery 58, is used as a source of electrical power for the operation of communications link 26.

Although a positive terminal 68 of battery pack 60 is electrically connected to link 26 when switch 48 is closed, the voltage supplied by power source 54 may be greater than the voltage at terminal 68. Thus, current may flow to link 26 from power source 54 rather than from battery pack 60. Moreover, because the voltage supplied by power source 54 may be greater than the voltage supplied by battery pack 60, current may also flow from power source 54 to battery pack 60, thereby recharging battery pack 60. This is more generally indicated in FIG. 3 by step 308, in which the battery pack is charged.

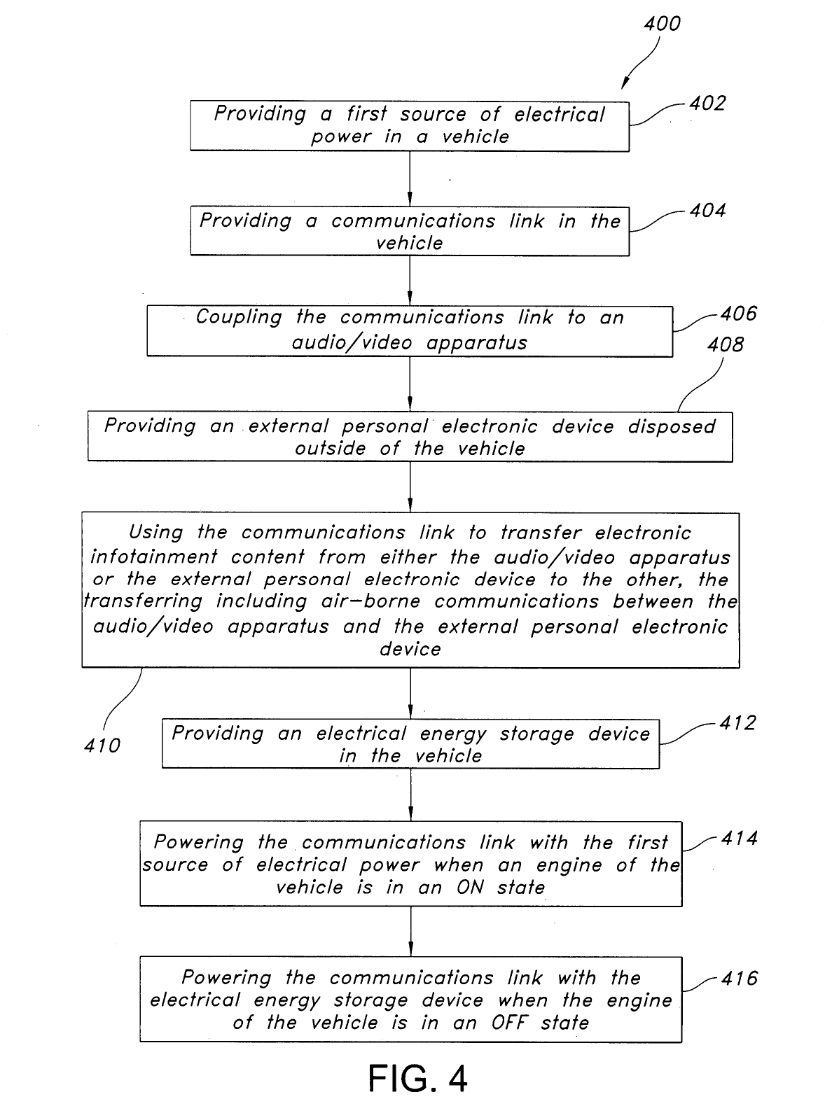

Another embodiment of a method 400 of the present invention for operating an audio/video apparatus in a vehicle is illustrated in FIG. 4. In step 402, a first source of electrical power is provided in a vehicle. For example, in the embodiment illustrated in FIG. 2, an electrical power source 54 is provided in a vehicle 12. In a next step 404, a communications link is provided in the vehicle. In vehicle 12, for instance, a wireless home-vehicle link 26 is provided. Next, in step 406, the communications link is coupled to an audio/video apparatus. For example, link 26 may be communicatively coupled to head unit 14 and/or RSE 16. In step 408, an external personal electronic device disposed outside of the vehicle is provided. More particularly, a PC 28 disposed outside of vehicle 12 may be provided. In a next step 410, the communications link is used to transfer electronic infotainment content from one of the audio/video apparatus and the external personal electronic device to the other. The transferring includes communicating with air-borne signals between the communications link and the external personal electronic device. In the illustrated embodiment, communications link 26 is used to transfer electronic infotainment content from external personal electronic device 28 to head unit 14 and/or RSE 16. Air-borne signals 38 may be communicated between communications link 26 and external personal electronic device 28 to effect the transfer. An electrical energy storage device is provided in the vehicle in step 412. For example, battery pack 60 may be provided in vehicle 12. In a next step 414, the communications link is powered with the first source of electrical power when an engine of the vehicle is in an ON state. In the illustrated embodiment, communications link 26 is powered with electrical power source 54 when engine 46 is in the ON state. That is, when ignition switch 48 is in a closed position such that current may flow from power source 54 to engine 46, then link 26 may also be powered by source 54. The user may close a switch 62 or similar in order to turn ON link 26 and place it in a state in which it is possible for link 26 to be powered. In a final step 416, the communications link is powered with the electrical energy storage device when the engine is in an OFF state. Specifically, when ignition switch 48 is in an open position such that current is prevented from flowing from power source 54 to engine 46, then current is also prevented from flowing from source 54 to link 26. In this case, link 26 may draw current from battery pack 60. Again, the user may close a switch 62 or similar in order to turn ON link 26 and place it in a state in which it is possible for link 26 to be powered.

In the embodiment shown in FIG. 1, radio frequency signals carrying the audio/video content are transmitted from the PC to the communications link. However, it is to be understood that it is within the scope of the invention for the audio/video content to be transferred from an external personal electronic device to the communications link in different ways. For example, the audio/video content may be transferred via an infrared transmitter and receptor, or may be carried by a conventional electrical conductor, such as a wire or cable.

In the embodiments discussed above, electronic infotainment content is transferred from an external electronic device to a vehicle. It is also possible, within the scope of the invention, for electronic infotainment content to be transferred in the opposite direction, i.e., from the vehicle to the external electronic device.

Also in the embodiments discussed above, the electrical energy storage device is shown to be in the form of a battery pack. However, it is also possible for another type of electrical energy storage device to be used, such as a storage capacitor or a single battery rather than a battery pack.

Moreover, personal electronic device 28 is discussed as being a PC in the embodiments above. However device 28 may be another electronic source of infotainment content, such as an iPod® or other brand of portable media player. Device 28 could also be a dedicated source of navigation information, which could be capable of downloading the navigation information from the internet.

In the above embodiments, head unit 14 and RSE 16 are shown as having no voltage supplied when switch 48 is open, and link 26 is shown as having no voltage supplied when switch 62 is open. It is to be understood that this may be a simplification for illustrative purposes of an actual implementation of the present invention. It is within the scope of the invention for switch arrangements to be provided such that at least a minimal level of current is supplied to head unit 14, RSE 16, and/or link 26 at all times such that memories therein may be maintained and light emitting diodes of these devices may be operable on a continuous basis.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. An infotainment system for a vehicle having a first source of electrical power, said system comprising:
an audio/video apparatus configured to be installed in the vehicle;
an external personal electronic device configured to operate outside of the vehicle;
a communications link communicatively coupled to each of said audio/video apparatus and said external personal electronic device, said communications link being configured to be installed in the vehicle and to transfer electronic infotainment content between said audio/video apparatus and said external personal electronic device, said transferring including communicating with air-borne signals between said communications link and said external personal electronic device, said communications link being configured to be powered by the first source of electrical power when an engine of the vehicle is in an ON state; and
an electrical energy storage device electrically connectable to said communications link, said electrical energy storage device being configured to power said communications link when the engine of the vehicle is in an OFF state.

2. The system of claim 1, wherein said first source of electrical power is configured to recharge said electrical energy storage device when the engine of the vehicle is in the ON state.

3. The system of claim 1, wherein said electrical energy storage device comprises a rechargeable battery pack.

4. The system of claim 1, wherein said ON state corresponds to an ignition switch being in an ON position, and said OFF state corresponds to said ignition switch being in an OFF position.

5. The system of claim 1, wherein said external personal electronic device comprises a personal computer.

6. The system of claim 1, wherein said audio/video apparatus includes a memory device, said transferring including storing the electronic infotainment content in said memory device.

7. A method of operating an audio/video apparatus in a vehicle, said method comprising the steps of:
providing a first source of electrical power in the vehicle;
providing a communications link in the vehicle;
coupling said communications link to the audio/video apparatus;
providing an external personal electronic device disposed outside of the vehicle;
using said communications link to transfer electronic infotainment content from one of the audio/video apparatus and said external personal electronic device to an other of the audio/video apparatus and said external personal electronic device, said transferring including communicating with air-borne signals between said communications link and said external personal electronic device;
providing an electrical energy storage device in the vehicle;
powering said communications link with said first source of electrical power when an engine of the vehicle is in an ON state; and
powering said communications link with said electrical energy storage device when the engine of the vehicle is in an OFF state.

8. The method of claim 7, comprising the further step of recharging said electrical energy storage device by using said first source of electrical power when the engine of the vehicle is in the ON state.

9. The method of claim 7, wherein said electrical energy storage device comprises a rechargeable battery pack.

10. The method of claim 7, wherein said ON state corresponds to an ignition switch being in an ON position, and said OFF state corresponds to said ignition switch being in an OFF position.

11. The method of claim 7, wherein said first source of electrical power comprises at least one of an alternator and a battery.

12. The method of claim 7, wherein said external personal electronic device comprises a personal computer.

13. The method of claim 7, wherein said audio/video apparatus includes a memory device, said transferring including storing the electronic infotainment content in said memory device.

14. A vehicle, comprising:
an engine having an ON state and an OFF state;
an audio/video apparatus including a memory device;
a communications link electrically connected to said audio/video apparatus, said communications link being configured to transfer electronic infotainment content from an external source to said memory device of said audio/video apparatus;
a first source of electrical power configured to power said communications link when said engine is in the ON state; and
an electrical energy storage device electrically connected to said communications link, said electrical energy storage device being configured to power said communications link when the engine is in the OFF state.

15. The vehicle of claim 14, wherein said communications link is configured to communicate with the external source via air-borne signals.

16. The vehicle of claim 14, wherein said first source of electrical power is configured to recharge said electrical energy storage device when the engine is in the ON state.

17. The vehicle of claim 14, wherein said electrical energy storage device comprises a rechargeable battery pack.

18. The vehicle of claim 14, wherein said vehicle further comprises an ignition switch, said ON state corresponding to said ignition switch being in an ON position, and said OFF state corresponding to said ignition switch being in an OFF position.

19. The vehicle of claim 14, wherein said first source of electrical power comprises at least one of an alternator and a battery.

20. An infotainment arrangement for a vehicle having an engine and an electrical power source, the engine having an ON state and an OFF state, said arrangement comprising:
an audio/video device configured to be installed in the vehicle and adapted to process infotainment content;
a memory device configured to store the infotainment content;
an electrical energy storage device; and
a communications link coupled to said audio/video device and said memory device, said communications link being configured to:
receive air-borne signals generated externally of the vehicle, said air-borne signals including the infotainment content;
be electrically coupled to and powered by said electrical energy storage device when the engine is in the OFF state; and
be electrically connected to and powered by the vehicle's electrical power source when the engine is in the ON state.

21. The arrangement of claim 20 wherein the electrical energy storage device comprises a rechargeable battery pack.

22. The arrangement system of claim 20 wherein the electrical energy storage device is adapted to be electrically connected to and recharged by the vehicle's electrical power source.
